(19) United States
(12) Patent Application Publication
(10) Pub. No.: US 2008/0220296 A1
(43) Pub. Date: Sep. 11, 2008

(54) PtRu core-shell nanoparticles for heterogeneous catalysis

(75) Inventors: Bryan W. Eichhorn, University Park, MD (US); Selim Alayoglu, Beltsville, MD (US)

Correspondence Address: DICKINSON WRIGHT PLLC, 1901 L. STREET NW, SUITE 800, WASHINGTON, DC, 20036, US

(73) Assignee: University of Maryland Office of Technology Commercialization, College Park, MD (US)

(21) Appl. No.: 12/007,203

(22) Filed: Jan. 8, 2008

Related U.S. Application Data
(60) Provisional application No. 60/883,845, filed on Jan. 8, 2007.

(51) Int. Cl. B01J 23/40; H01M 4/00; H01M 8/04

(52) U.S. Cl. 429/17; 502/326; 429/40

(57) ABSTRACT

PtRu nanoparticles, which contain Pt shell and a ruthenium-based nanoparticle core, and which nanoparticles may be used advantageously in oxidation of hydrogen containing relatively large amounts of CO.

### CROSS-REFERENCE TO RELATED APPLICATIONS

This application claims priority to U.S. Ser. No. 60/883,845, filed on Jan. 8, 2007, in the U.S. Patent and Trademark Office.

### STATEMENT REGARDING FEDERALLY SPONSORED RESEARCH OR DEVELOPMENT

The work leading up to the present invention was sponsored, at least in part, by NSF CHE 0401850. As such, the U.S. government may have certain rights in the present invention.

### BACKGROUND OF THE INVENTION

The present invention relates to PtRu nanoparticles, catalysts, and a method of using the same in proton exchange membrane (PEM) fuel cells, for example.

### DESCRIPTION OF THE BACKGROUND

In order to improve the performance of PEM fuel cells, as well as reducing costs thereof, it is necessary to reduce overpotentials associated with the O₂ reduction reactions (ORR) and to lower cathode precious metal (Pt) catalyst loading with more cost effective architectures. In addition, improvement of tolerance to contaminates, such as CO, is critically important in order to effect of large scale implementation. Pt alloys with enhanced activities have been identified as one of the most promising materials for meeting these challenges. A wide array of studies have addressed conventional Pt alloy electrocatalysts and, more recently, nano-architectured electrocatalysts for improved O₂ reduction. While significant progress has been made at reducing cathode Pt loading in PEM fuel cells, cathode electrocatalyst compositions and architectures that provide improved performance for reduced loading down to 0.2 mg of Pt/cm², for example, and long-term stability under electrochemically active conditions have not yet been identified.

The development of bimetallic heterogeneous catalysts has historically been achieved mainly through chemical intuition and empirical synthetic approaches. Catalytic reforming, fuel cell electrocatalysis, hydrodesulfurization and partial alkene oxidation are a few examples of important technologies that rely on bimetallic systems which have been developed over the last several decades. Recent advances in surface science techniques, analytical instrumentation and first-principles calculations provide some mechanistic insight into the atomistic surface chemistry governing catalytic activity and offer a basis for true rational design of heterogeneous catalysts. However, to develop bulk scale catalysts beyond fundamental surface science studies, it is necessary to develop and couple new nanoparticle (NP) synthesis methods with first principles of theoretical design and surface science modeling-studies. To date, this has not been accomplished for PtRu bimetallic nanoparticles, which are producible in bulk in a controllable manner, and which exhibit improved catalytic performance for reduced loading as well as long term stability under electrochemically active conditions.

Thus, a need exists for PtRu bimetallic nanoparticles which can be produced in bulk in a controllable manner, and which exhibit improved catalytic performance for reduced loading as well as long term stability under electrochemically active conditions.

### SUMMARY OF THE INVENTION

Accordingly, it is an object of the present invention to provide PtRu core-shell nanoparticles (NPs) which exhibit a new activity and selectivity.

It is, further, an object of the present invention to provide PtRu core-shell nanoparticles having improved catalytic performance for reduced loading.

Moreover, it is an object of the present invention to provide PtRu core-shell nanoparticles having long term stability under electrochemically active conditions.

It is also an object of the present invention to provide a proton exchange membrane fuel cell containing the present PtRu core-shell nanoparticles as catalysts, as well as a vehicle powered by the fuel cell.

### BRIEF DESCRIPTION OF THE DRAWINGS

FIG. 1. TEM images taken at 125 K magnification: (a) Ru@Pt NPs, (b) the physical mixture of Pt NPs (7-8 nm) and Ru NPs (3 nm); and (c) PtRu alloy NPs. Insets show the size distribution histograms based on counting 200 particles each. The dashed lines show the average size of each particle-type.

FIG. 2. XEDS point analysis shows that the core@shell nanoparticles have Pt and Ru elements in 25-75% range with a nominal 48% Pt by atom, and is based on the data shown in Table 2.

FIG. 3. Micro-Raman spectra of Pt NPs (a), Ru NPs (b), the physical mixture of Pt and Ru NPs (c), and Ru@Pt NPs (e) after annealing at 700° C. for 2 hours; of Ru@Pt NPs as-made (d). The dashed and solid lines show the peak centers for RuO₂ (E_{g} phonon mode), and amorphous PtO respectively.

FIG. 4. IR-CO probe spectra of the physical mixture of Pt and Ru (a), Ru@Pt (b), and PtRu (c) NPs colloidal suspensions. The dashed lines show the peak centers for the linearly adsorbed CO on the surface metals.

FIG. 5. XRD patterns of the Ru NPs those synthesized over dry glycol and annealed at 500° C. (a), PtNPs (b), Ru@Pt NPs (c), and PtRu alloy NPs (d). The lines show the FCC Pt phase, and the solid lines the FCC PtRu alloy phase.

FIG. 6. XRD patterns of the physical mixture of Pt and Ru NPs (b, and d), and the Ru@Pt core/shell NPs (a, and c); as-made (a, and b), and after annealing at 500° C. for 12 hours (c, and d). The dashed lines show the peak centers for the FCC Pt NP phase, and the solid lines those for the FCC alloy phase.

FIG. 7. H₂O conversion rates plotted versus temperature for Ru(Pt core/shell NPs (open circles), PtRu alloy NPs (open rectangles), and Pt—Ru mixture (open triangles) for 0.1% (a), and 0.2% (b) by volume CO contaminated gas feeds.

FIG. 8. The conversion rates of CO₂ O₂, and H₂O; and the selectivity for CO formation are plotted for the RuPt NPs catalyst. The gas feed of 1% CO, 1% O₂, 50% H₂ and balance Ar with a total flow rate of 200 Nm 1/min is promptly provided for the reaction. Note that the O₂ consumption rate at 80° C. far more exceeds those of alloy and mixture NPs catalysts, which are not shown.

FIG. 9. X-Ray diffraction profiles of (a) Ru NPs after anneal at 500° C. for 12 hours, (b) Pt NPs, (c) PtRu alloy NPs, and (d) Ru@Pt NPs. Blue lines represent the HCP Ru phase (JCPDS file 06-0663), and red lines the FCC Pt phase (JCPDS file 04-0802).

FIG. 10. FT-IR spectra of Ru@Pt and a physical mixture of monometallic Pt and Ru NPs suspensions after bubbling CO through the solutions for 15 min.

FIG. 11. (left) Temperature programmed reaction (TPR) results for the different Pt—Ru catalysts showing H₂O formation vs. temperature for H₂ feeds contaminated by 0.1% CO by volume. The H₂O yields are plotted as % maximum formation based on the limiting reactant O₂. With complete CO conversion in the 0.1% feed, the maximum formation of water is 90% The monometallic Pt remains in the baseline in this temperature range and does not light off until 170° C. (right) % formation of H₂O (open markers) and % conversion (solid markers) are plotted against temperature for the core-shell (black) and alloy (red) NPs catalysts for H₂ feeds contaminated by 0.2% CO. In these feeds, the maximum H₂O yields is 80% when CO is preferentially oxidized. CO is normalized to its inlet concentration. Note that 70% of the CO is already converted to CO₂ at 30° C. for the Ru@Pt catalyst.

### DETAILED DESCRIPTION OF THE PREFERRED EMBODIMENTS

The present invention is based, in part, upon the discovery of a nanoparticle (NP) catalyst containing a Ru core covered with a shell of Pt atoms (i.e. a Ru@Pt core-shell NP) that has predictable catalytic properties that are markedly different from nanoparticles of “bulk” PtRu alloys or monometallic Pt and Ru mixtures of identical loadings and compositions. The present inventors demonstrate herein the unique properties of the Ru@Pt NP catalyst by way of preferential CO oxidation in hydrogen feeds (PROX), a reaction of key importance for the practical implementation of hydrogen fuel cells. Our DFT studies have indicated the origin of the enhanced activity for the core-shell NP's and provide a fundamental mechanistic explanation of the hydrogen-promoted CO oxidation reaction at low temperatures. The results disclosed herein show that the electronic structure, catalytic activity and chemical selectivity of bimetallic heterogeneous catalysts can now be designed, implemented and turned through a combination of theoretical analysis and core-shell NP synthesis in a controllable and reproducible manner.

We have shown that Pt monolayers on base metals sustain the high activity of pure Pt for H₂ activation kinetics, whereas at the same time bind adsorbates (e.g. CO) much weaker than pure Pt. The core-shell architecture provided by the present invention, where only one type of atom is present on the surface, invokes a combination of “ligand” and surface strain effects without any mechanistic complications of the alloy surface bifunctionality. The latter refers to more common bimetallic catalysts, where both alloy components are present on the surface. In such bimetallic systems, the more oxophilic metal acts as an oxygen activator (i.e. to form surface OH), which facilitates the oxidation of the CO adsorbed on neighboring, less oxophilic metal centers. In contrast, core-shell catalysts have only one type of surface metal but their electronic structure and catalytic properties are substantially modified because of the interactions of the shell atoms with the core atoms. The kinetically-stabilized core-shell structure has already proven itself as a novel architecture for NO reduction over the PtCu bimetallic system. In situ chemical and electrochemical deposition of Pt and other metals onto core NPs (including Ru) has been reported but the resulting catalyst NP structure/architecture is difficult to assess in these systems. However, the lack of controlled bulk synthetic procedures and the limited structural and spectroscopic information for PtRu systems has hindered mechanistic interpretation and direct comparison with other NP architectures.

The present invention is based, at least in part, upon the discovery of a Ru@Pt core-shell NP catalyst that is distinctly different from PtRu alloy and from the mixed monometallic systems of the same composition. In PROX reactions, the Ru@Pt NPs are far more active for CO oxidation than alloy and monometallic NP catalysts. Because the Ru metal is confined and kinetically trapped inside a Pt shell, the conventional bifunctional mechanism cannot be implicated since CO oxidation necessarily occurs entirely on the Pt surface sites; no Ru is exposed on the NP's surface. Through DFT modeling, the present inventors have determined that the enhanced CO oxidation is achieved through modification of the electronic structure of the Pt surface by the presence of subsurface Ru. This modification significantly destabilizes CO on Pt, leading to lower CO saturation coverage, thereby providing more adsorbate-free active sites where O₂ and H₂ can be activated. At the same time, this electronic modification greatly accelerates the CO oxidation reaction through a substantial destabilization of the adsorbed reactive intermediates.

The present invention is also based, at least in part, upon the discovery of a synthesis of a nanoparticle (NP) catalyst containing a Ru core covered with an approximate 1-2 monolayer-thick shell of Pt atoms (i.e. a Ru@Pt core-shell NP). The distinct catalytic properties of these well-characterized core-shell nanoparticles have been demonstrated for preferential CO oxidation in hydrogen feeds (PROX) and subsequent hydrogen light-off. For H₂ streams containing 1000 ppm CO, H₂ light-off is complete by 30° C., which is significantly better than traditional PtRu nano-alloys (85° C.), monometallic mixtures of nanoparticles (93° C.) and pure Pt particles (170° C.). Density Functional Theory (DFT) studies suggest that the enhanced catalytic activity for the core-shell NP's originates from a combination of (i) an increased availability of CO-free Pt surface sites on the Ru@Pt NP's, which are necessary for O₂ and H₂ activation, and (ii) a hydrogen-mediated low-temperature CO oxidation process that is clearly distinct from the traditional bi-functional CO oxidation mechanism. These characteristics of the PtRu core-shell nanoparticles disclosed herein are plausibly considered to be responsible for the observed properties thereof. These properties are:

1) improved catalytic performance under reduced Pt loading, and

2) long term stability under electrochemically active conditions.

Generally, the nanoparticles of the present invention have a size of from about 1-15 nm, and preferably from about 3-10 nm. Most preferably, the nanoparticles have a size of from about 4-8 nm. These Ru@PT NPs exhibit a superior combined activity and selectivity for oxidizing hydrogen in the presence of CO in CO-rich gas feeds having from about 10 to 10,000 ppm of CO therein.

### TERM DEFINITIONS

The following terms used throughout the present specification and claims are as defined herein below:

1) Pt and Ru are the metals platinum and ruthenium, respectively. The nanoparticles described herein may be referred to interchangeably as PtRu nanoparticles, Ru@Pt NPs, Ru@Pt core-shell NPs or PtRu core-shell nanoparticles.

2) nanoparticle generally means particles having a size of less than 100 nm, and as also particularly defined throughout this specification.

3) TEM means Transmission Electron Microscope.

4) XEDS means X-ray Energy Dispersive Spectroscopy.

5) PVP means polyvinylpyrrolidone, and of a molecular weight in the range of about 30,000 to 75,000, or as specifically indicated in the present specification.

6) high-boiling solvent means a solvent having a reflux temperature of at least 150° C., and preferably at least 175° C.

Thus, the present invention provides a nanoparticle architecture containing a Pt shell that coats a ruthenium/ruthenium oxide nanoparticle core. The structure of the particle is different from traditional alloy particles and it is believed to be the architecture and the chemical state of the metals in the nanoparticles that provides the superior catalytic activity.

The nanoparticles of the present invention are more efficient at oxidizing hydrogen in CO-rich gas feeds up to 1000 ppm of CO than any other catalysts reported to date. Thus, the present nanoparticles provide a superior anode catalyst for hydrogen fuel cells that is far more active and tolerant of CO impurities than are the current state-of-the-art catalysts. The present nanoparticles are also more efficient at activating molecular oxygen for ORR processes. In addition, the Pt shell thereof prevents acid attack of the Ru core in PEM fuel cell conditions. Hence, the present nanoparticles maybe acid-resistant under electrochemically active conditions.

Generally, any platinum salt precursors that can be reduced to the metallic state, such as PtCl₂ and Pt(acac)₂ [acac=acetylacetonate], H₂Pt (IV) Cl₆, PtCl₄, or any Pt complex that can be reduced to the metallic state, such as Pt (C₂H₄)₃, Pt (COD)₂, Pt (PPh₃)₄, may be used as Pt-shell material. Any ruthenium salt precursor that can be reduced to the metallic state, such as RuCl₃, Ru(acac)₃, Ru₂(CO)₆Cl₄ and mixtures thereof, can be used as a starting material for the synthesis of Ru-core.

Further, in general, any polyols with boiling points in excess of 150° C., such as propylene glycol (propane 1,2-diol), trimethylene glycol (propane 1,3-diol, diethyhlene glycol, triethyelene glycol etc. may be used as solvent. Any organic solvent inert to ruthenium (catalyst) can be used with a suitable reducing agent and ligand combination.

Examples of reducing agents are alcohols, amines, NaBH₄, butyllithium, methyllithium, hydrazine or other similar agents. Examples of other solvents are decahydronaphthalene, octylethers, oleylamine, hexadecane, trioctylphosphine, diglyme, glycol, hexanediol or combinations thereof.

Powder x-ray diffraction technique is used to characterize the Ru@Pt core/shell NPs. The particles might also be made amorphous, however, and, therefore, give no diffraction. Notably, the architecture (i.e. Ru core with a Pt shell) is an important feature but the structure (Ru metal and Pt metal as shown by XRD) is not limative.

The present NPs as made may have anywhere from 100% Ru (0)-0% (Ru⁺⁴) to 0% Ru(0) to 100% (Ru⁺⁴) See also the examples below.

The synthesis of the present Ru@Pt core-shell NPs is conducted using Schlenk line techniques. Such techniques as well-known and generally used for the preparation of air-sensitive compounds.

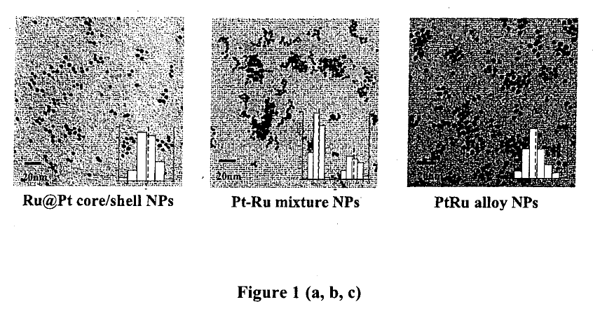

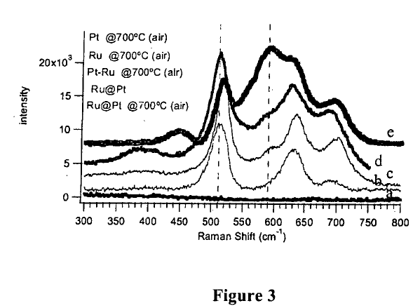

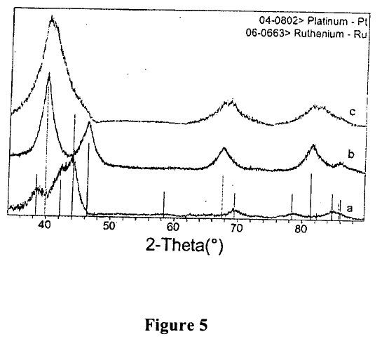

TEM imaging reveals small fairly monodisperse nanoparticles of about 3.0 nm mean size. See FIG. 1c. The XRD pattern therefor is broad and asymmetric centered around 42° (20), indicating the amorphous nature of the final particles. Only Ru nanoparticles which diffract with hexagonal close packed (HCP) Ru pattern are those made over dried glycol and annealed at 500° C. for 12 hours. See FIG. 5b. Micro-structure analysis yields rutile RuO₂ pattern, but all oxygen phonon modes being shifted to lower Raman shifts by 20 cm⁻¹ taken as evidence for amorphous nature of the resulting nanoparticles. For surface characterization, the colloidal suspension of the as made Ru NPs is bubbled with CO for 15 minutes, and CO probed surface is monitored with FT-IR. The peak positioned at 2030 cm⁻¹ is assigned to CO stretching on Ru Surface (FIG. 3a). XPS results, in Table 1 below show a higher binding energy by 0.2 eV for the Ru metal, as compared to Ru standard.

TABLE 1
X-ray Photoelectron Spectroscopy shows electron binding energies of Ru
3d_{5/2} and Pt 4f_{7/2} core levels for bimetallic PtRu alloy, and Ru@Pt
core/shell Nps, monometallic Ru, and Pt NPs; and Pt wire, Ru and RuO₂
powders as reference standards (to the left of the table). It also shows
binding energy shifts for these energy levels relative to Pt and Ru NPs.

| | Ru 3d_{5/2} (eV) | | ΔRu 4f_{7/2} (eV) | | | | | |
|---|---|---|---|---|---|---|---|---|
| | Ru⁰ | Ru⁴⁺ (RuO₂) | Pt⁰ | Pt²⁺ (PtO) | ΔRu 3d_{5/2} | | ΔPt 4f_{7/2} | |
| Pt (wire) | — | — | 71.33 | 72.40 | — | — | −0.06 | 0.10 |
| Ru (powder) | 280.28 | 281.26 | — | — | 0.21 | 0.00 | — | — |
| Pt (Nanoparticles) | — | — | 71.39 | 72.50 | — | — | — | — |
| Ru | 280.49 | 281.26 | — | — | — | — | — | — |
| (Nanoparticles) | | | | | | | | |
| Ru@Pt (NPs) | 280.36 | 281.17 | 71.55 | 72.73 | 0.13 | 0.09 | −0.16 | −0.23 |
| PtRu alloy (NPs) | 280.35 | 281.21 | 71.71 | 72.54 | 0.14 | 0.05 | −0.32 | −0.04 |

Having described the present invention, reference will now be made to certain examples which are provided solely for purposes of illustration and are not to be considered limitative. All preparations of the present Ru@Pt core-shell NPs below were conducted using Schlenk line methodologies.

### Example 1

Pt is coated over as-made Ru seeds in a separate deposition sequence. 54 mg PtCl₂ is dissolved in 40 mL colloidal Ru suspension, the mixture is heated to 130° C. under vigorous stirring, and then brought to a boil with a temperature ramping as slow as 1-2° C. per minute. The reaction is quenched by removing the reaction flask off the mantle after 1.5 hours of constant refluxing. The Ru@Pt nanoparticles show a mean particle size greater than that of monometallic Ru nanoparticles, with a narrow size distribution (FIG. 1a).

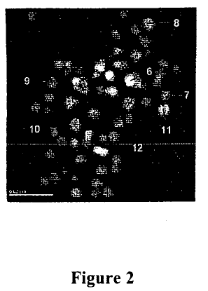

Randomly chosen NPs for STEM point analysis have both Pt and Ru elements in 25-75% range (FIG. 2). The data depicted in FIG. 2 are shown below in Table 2.

TABLE 2
XEDS point analysis show that the core@shell
nanoparticles have Pt and Ru elements in 25-75%
range with a nominal 48% Pt by atom.

| # | Size (nm) | % Pt by atom | % Ru by atom |
|---|---|---|---|
| 6 | 4.5 | 52.3 | 47.7 |
| 7 | 4 | 25.3 | 74.7 |
| 8 | 5.5 | 49.9 | 50.1 |
| 9 | 4 | 26.9 | 73.1 |
| 10 | 6 | 59.5 | 40.5 |
| 11 | 5 | 39.1 | 60.9 |
| 12 | 4 | 29.9 | 70.1 |

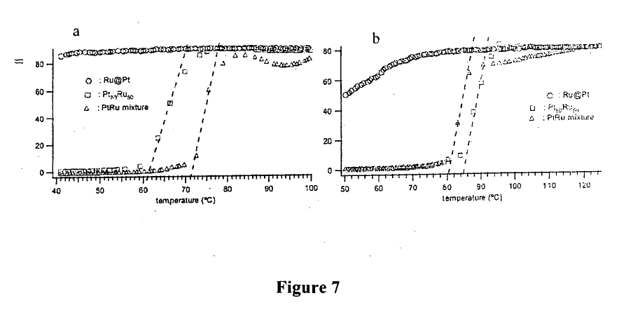

Micro-Raman spectrum exhibits a similar pattern as monometallic Ru NPs, except a shoulder at 590 cm⁻¹. Annealing the particles at 700° C. for 2 hours yields a sharper feature centered at about cm⁻¹ along with all modes for the rutile phase Raman shifted to higher frequencies as shown in FIG. 3c. The peak at 590 cm⁻¹ is assigned to amorphous PtO, and believed to play an important role in O₂ activation kinetics of the core/shell catalyst in PROX reaction compared to the alloy and physical mixture catalysts (FIG. 7). As FIGS. 3a-c reveals, no monometallic system has the 590 cm⁻¹ feature (before and) after annealing. The physical mixture shows a weak feature upon annealing, however, the core/shell structure intrinsically exhibits the 590 cm⁻¹ peak (FIGS. 3d, and e respectively). X-Ray photoelectron spectrum for the Pt 4f levels is deconvolated into two signals one for Pt metal and another for PtO, both being moved to higher binding energies relative to monometallic Pt NPs and Pt standard.

PtRu alloy NPs may be synthesized by co-deposition in high boiling solvent, as noted above. Generally, as noted above, and as another example of the present invention, metal precursors of Ru and Pt, such as [Ru(CO)₃Cl₂]₂ dimer and Pt(acac)₂, for example, are co-reduced in glycol while being capped with PVP. Generally, PVP molecular weights of 30,000 to 75,000 are used, while molecular weights from about 40,000 to 60,000 are preferred. A typical synthesis may use [Ru(CO)₃Cl₂]₂, Pt(acac)₂ and 55 mg PVP₅₅₀₀₀ in glycol. X-Ray diffraction pattern in FIG. 5(e) is indexed to a FCC lattice whose (111) peak is centered at 40.30 (20) for such a compound. IR-CO probe measurement gives a major feature at 2020 cm¹, and a shoulder around 2050 s, as in FIG. 3(d). The former is assigned to linearly bound CO on Ru, and the latter to terminal CO on Pt. Both are shifted to higher wavenumbers with respect to the values reported elsewhere for oxide free clusters, as also predicted by the core level shifts of Pt and Ru in our XPS. See Table 1 above.

Catalysts may be prepared by adding a support material, such as alumina, preferably γ-Al₂O₃, to a colloidal suspension of nanoparticles, and drying the slurry under vacuum. Typically, a suspension of nanoparticles and γ-Al₂O₃, for example, are mixed and vacuum dried at temperatures over 100° C. while vigorously stirring the mixture. Such composition yields a 1% by weight Pt alumina supported bimetallic catalyst. The catalyst is washed with polar organic solvent, such as acetone several times and equip-volume mixture of acetone and ethanol, for example, then baked at 60° C. overnight.

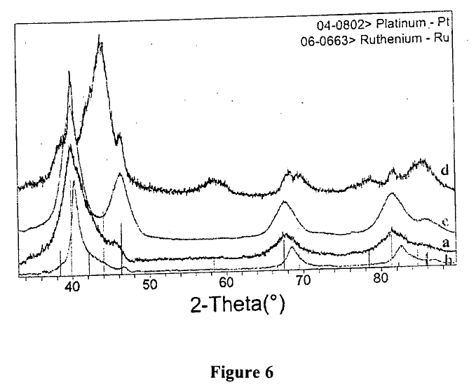

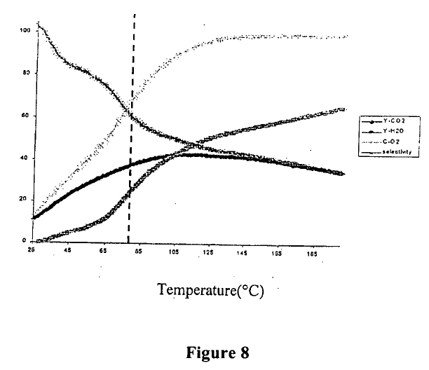

The catalysis is carried out using 105 mg catalyst of any kind. The catalytic rig is designed in a flow-through fashion. An inlet velocity of gases of 0.21 m/s, and a total flow rate of 400 NmL/min is employed. The gas mixture for the PROX reaction is composed of 0.1-0.2% (99.999% pure). The catalysts are reduced in 50% H₂ (99.999% pure), and balance Ar (99.999% pure). The catalysts are reduced in 50H₂ at 200° C. prior to catalysis. The temperature is set to 200° C. and the heating ramp is 1.6° C./min. The rate of H₂O formation is plotted versus temperature for each core@shell, alloy and physical mixture NPs catalysts for 0.1% and 0.2% by volume CO contaminated H₂ feeds, in FIGS. 6a and 6b, respectively. The Ru@Pt NPs catalyst shows a superior catalytic performance compared to other PtRu bimetallic catalysts. FIG. 8 shows the conversion kinetics for CO, O₂, and H₂O, 50% H₂ and 48% Ar by volume. The flow rate is 200 Nml/min. The O₂ conversion at 80° C. is 70% compared to 13% and 1% for alloy and mixture NPs catalysts, respectively.

### Example 2

The Ru@Pt core-shell NPs were synthesized by using a sequential polyol process. Ru(acac)₃ (acac=acetylacetonate) was initially reduced in refluxing glycol in the presence of PVP stabilizers (MW=55,000). The resulting Ru NPs (mean particle size=3.0 nm) were subsequently coated with Pt by adding PtCl₂ to the Ru/glycol colloid and slowly heating to 200° C. The PtRu alloy NPs were synthesized via co-reduction of the [Ru(CO)₃Cl₂]₂ dimer and Pt(acac)₂ with glycol and PVP stabilizer at 200° C. Monometallic Pt NPs and Ru NPs were prepared from PtCl₂ and Ru(acac)₃, respectively, using slight modifications of published procedures. To make a physical mixture of monometallic Pt and Ru NPs, the separate colloids were mixed. All catalysts were prepared with 1.0 wt % Pt loadings by impregnating γ-Al₂O₃ supports with the colloids in accordance with a known procedure.

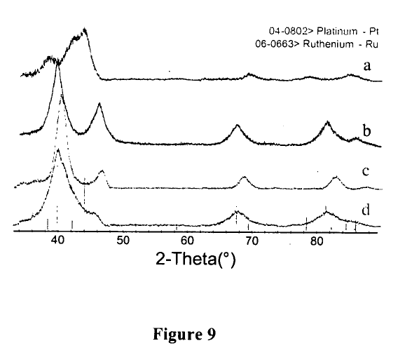

The Ru@Pt NPs show a mean particle size of 4.1 nm (FIG. 9a), which is larger than that of monometallic Ru NPs (3.0 nm), and smaller than that of monometallic Pt NPs (6.1 nm). The HR-TEM image in the inset shows a typical Ru@Pt nanoparticle with {111} lattice fringes. Randomly chosen NPs for TEM EDS point analysis show that each particle has both Pt and Ru with an average Pt:Ru ratio of 40:60 error. The bulk PtRu alloy NPs show an average size of 4.4 nm (FIG. 9(b)). The HR-TEM images of the PtRu alloy NPs also show prominent FCC {111} lattice fringes (FIG. 9(b)). Using a known shell model, the composition of the particles and taking into account the precision of the TEM measurements, we concluded that the Pt shell of the Ru@Pt NPs is 1-2 monolayers (ML) thick, which we have found to be the Pt-coverage yielding superior catalytic activity.

The XRD profiles of the Ru@Pt NPs show face centered cubic (FCC) diffraction peaks for the Pt shell with an additional reflection at ˜42° (a shoulder next to the Pt (11) peak at 39.8°) that arises from the poorly-crystalline HCP Ru core. The refined Pt lattice parameter (Lebail profile fit) for the Pt shell of the Ru@Pt particles gives a 3.910(1) Å FCC lattice constant, which is slightly compressed from that of pure Pt at 3.923 Å. While diffraction from monolayer films has been well described in a theoretical framework, it is rarely observed due to the lack of scattering matter from a thin film surface. Bulk samples of monolayer coated NPs provide a higher density of scattering matter and enhanced X-ray diffraction relative to thin film samples. The XRD data for the Ru@Pt particles with approximate monolayer coverage show relatively strong Pt 111 diffraction peak whose peak position is shifted to higher 2θ compared to bulk Pt and is consistent with a compressed lattice. Additionally, the 002 reflection of Ru@Pt is shifted from its normal position to lower 2θ and has a lower intensity relative to bulk Pt. Monometallic Pt NPs synthesized under identical conditions show bulk Pt diffraction patterns with no anomalies in their peak positions. As the Pt shell becomes thicker with additional overlayers, the peak positions for the 111 diffraction shift to their “normal” position with increasing intensities. We attribute the anomalies in the diffraction data for the monolayer shells to incomplete lattice formation and strains associated with the 2D structure. These anomalies also suggest that the observed diffraction peaks do not arise from low concentrations of pure Pt NPs in the Ru@Pt sample.

Annealing the Ru@Pt NPs at 500° C. in vacuum induces alloy formation, which is evidenced from the contracted FCC unit cell with a=3.889(1) Å (FIG. 9(c)). The XRD profile is virtually identical to that of the authentic alloy and its corresponding lattice parameter (a=3.867(1)Å). As expected, both alloys show unit cells that are intermediate to pure Pt and Ru phases.

X-Ray photoelectron spectra (XPS) for the Ru@Pt NPs show a Ru:Pt ratio of 58:42, which is again consistent with the precursor composition. The Pt 4f levels show two signals; one for Pt metal (80%) and another for PtO (20%), that are both shifted to higher binding energies relative to the monometallic Pt NPs and the Pt standard. The Ru XPS data show metallic Ru (67%) and R⁴⁺ (33%) components. The latter is attributed to RuO₂. For Ru, the metal and Ru⁴⁺ levels are shifted to lower energy relative to the monometallic Ru NPs. Similarly, the PtRu alloy NPs show a total of 45% Pt by atom, about 80% of which is for Pt metal. The Ru^{o}:R⁴⁺ ratio is 63:37. However, other Ru^{o}/Ru⁺⁴ ratios may be obtained, and even 100% Ru⁰. The electronic changes in the core levels of Pt and Ru atoms, as determined by XPS, are also consistent with alloy formation. Chloride was not detected in any of the samples.

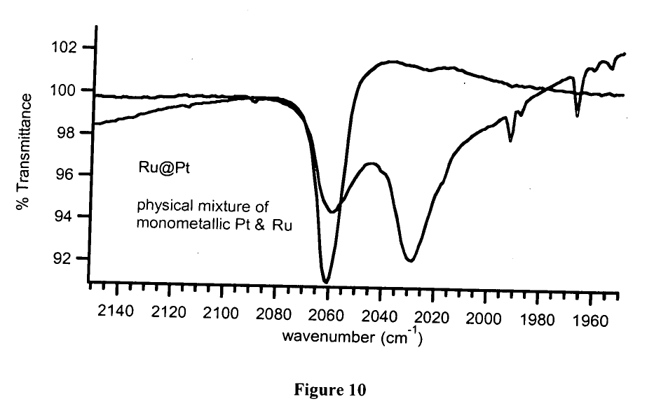

To probe the NP surface composition, the as-prepared NPs were dosed with CO in the colloidal suspension and subsequently monitored by FT-IR (FIG. 10). The IR spectrum of a mixture of monometallic Pt and Ru NPs is included in FIG. 10 and clearly shows the distinct Ru—CO (2029 cm⁻¹)³⁵ and Pt—CO (2059 cm⁻¹) peaks. The IR spectrum of the Ru@Pt NPs shows a single peak centered at 2061 cm⁻¹, which is indicative of a Pt surface. Although the peak is slightly shifted to higher wave numbers relative to monometallic Pt NPs CO peak positions are sensitive to synthetic conditions and CO coverage with up to 7 cm⁻¹ variation in frequency in a given experiment. However, as described previously, the IR-CO probe clearly differentiates surface Ru from surface Pt.

The combined TEM, XRD, XPS and IR-CO probe data are all consistent with the core-shell structure for the Ru@Pt NPs and clearly differentiate them from the PtRu alloy NPs. The XRD and XPS studies all suggest an amorphous mixed Ru⁺⁴/Ru⁰ core that is coated by a Pt shell. Pure Ru NPs show the same characteristics except for higher Ru⁺⁴/Ru⁰ ratios and slightly higher binding energies. Empirically, we observe that the RuO₂ shell is required for Pt coating. Ru particles prepared under rigorous anaerobic conditions do not provide good seeds for core-shell particle growth and result in the formation of phase-separated monometallic mixtures. However, Ru NPs are readily reduced to the metallic state in flowing H₂ at room temperature. As such, it appears that the catalytically active Ru@Pt NPs are metallic after conditioning in H₂ and these structures have significantly different activities from those of the PtRu alloy and monometallic Pt and Ru structures under identical loadings and conditions.

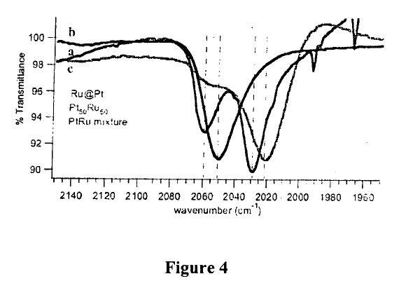

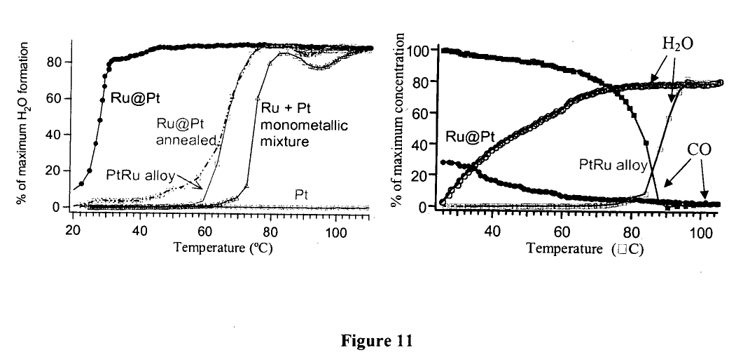

To compare and contrast the activity of the core-shell NPs with that of the alloys and monometallic NPs, we evaluated the PROX reaction using H₂ feeds contaminated by 0.1-0.2% CO by volume, along with 0.5% O₂. The temperature programmed reaction (TPR) data for the core-shell, alloy and monometallic mixture are shown in FIG. 11. For reference, our pure Pt NP catalysts under these conditions show H₂ oxidation onset (light-off) at 175-180° C., which is consistent with literature reports. In contrast, the PtRu alloy and monometallic mixture catalysts show 62° C. and 72° C. light-off temperatures (1000 ppm CO), respectively (FIG. 4). This behavior is consistent with the well-known bifunctional promotional effect in PtRu systems. The bulk PtRu alloy and monometallic mixture show complete CO conversion at 85° C. and 93° C., respectively, for H₂ feeds containing 1000 ppm CO.

The Ru@Pt core-shell catalysts show the highest activity for all the different architectures studied to date (FIG. 11). In contrast to the other two bimetallics just described, CO oxidation precedes H₂ oxidation to a greater extent and both occur at much lower temperatures with the core-shell catalyst (i.e. it is a more active and more selective PROX catalyst). For the 1000 ppm CO feeds, CO oxidation is completed below 20° C. and H₂ light-off occurs at 22° C. With 2000 ppm CO, the core-shell catalyst shows 65% CO conversion by 20° C. with a broad H₂ light-off starting at 25° C. In 1% CO feeds with 0.5% O₂, the Ru@Pt catalyst shows 70% oxygen conversion with 80% selectivity as compared to <10% conversion and ˜50% selectivity for the PtRu alloy and mixed monometallic systems. While higher selectivities can be found for other Pt catalysts, those systems require reducible oxide supports for oxygen activation and comparable alumina-based catalysts are not as active. Since no reducible oxide supports were employed in the present system, the origin of enhanced PROX activity for Ru@Pt must be assigned to changes in the electronic structure of the Pt shell.

The Ru@Pt catalyst can be cycled at 200° C. for several hours without loss of activity. Importantly, annealing the Ru@Pt catalyst at 500° C. for 12 hrs induces alloy formation (FIG. 6) and the resulting catalytic performance then drops to that of the authentic RuPt alloy (FIG. 11). In addition and in agreement with reports on Pt/Al₂O₃ PROX catalysts, CO oxidation is significantly slower in the absence of H₂, which suggests that the oxidation process is mediated by the presence of H₂. Previous studies have speculated on the origin of this effect but none have fully explained this unusual behavior. Furthermore, because the Ru metal is buried in the core of the particle, the traditional bi-functional mechanism is clearly not operative in the present system.

The present Ru@Pt NPs may be used advantageously in many reactions, such as PROX, ORR, WGS, reforming and those generally involving hydrogenation and CO-tolerant electrocatalysis.

Furthermore, since the present Ru@Pt NPs exhibit a superior combined activity and selectivity for oxidizing CO in the presence of hydrogen in CO-rich gas feeds, as defined above, these NPs may be used advantageously as anode catalysts for PEM fuel cells using a CO-rich hydrogen feed.

Examples of CO-rich hydrogen sources include off-gases from various industrial processes.

Also, examples of PEM fuel cells may be noted from U.S. Pat. Nos. 6,020,083; 6,010,798 and 7,108,937, which are all incorporated by reference herein in the entirety.

U.S. Ser. No. 11/638,572, filed on Dec. 14, 2006 and U.S. Ser. No. 60/883,845, filed on Jan. 8, 2007, are both incorporated by reference herein in the entirety.

Having described the present invention, it will be apparent to one of ordinary skill in the art that many changes and modifications may be made to the above-described embodiments with departing from the spirit and the scope of the present invention.

What is claimed is:

1. PtRu nanoparticles, comprising a Pt shell and a ruthenium-based nanoparticle core.

2. The PtRu nanoparticles of claim 1, wherein the ruthenium-based nanoparticle core comprise ruthenium or ruthenium/ruthenium oxide.

3. The PtRu nanoparticles of claim 1, wherein the Pt and Ru co-exist in a bimetallic form.

4. The PtRu nanoparticles of claim 1, having a size of from about 1 to 15 nm.

5. The PtRu nanoparticles of claim 4, having a size of from about 3 to 10 nm.

6. The PtRu nanoparticles of claim 5, having a size of from about 4 to 8 nm.

7. The PtRu nanoparticles of claim 1, having a % Pt by atom of from about 20 to 60%.

8. The PtRu nanoparticles of claim 1, having a % Ru by atom of from about 80 to 40%.

9. The PtRu nanoparticles of claim 1, wherein the Pt shell is 1-2 monolayers in thickness.

10. The PtRu nanoparticles of claim 1, which are acid resistant under electrochemically active conditions.

11. The PtRu nanoparticles of claim 2, wherein the core comprises Ru⁰/Ru⁺⁴ in a ratio of about 100-0:0-100.

12. The PtRu nanoparticles of claim 11, wherein the core comprises Ru^{o}/Ru⁺⁴ in a ratio of about 60-70:40-30.

13. A supported catalyst, comprising the PtRu nanoparticles of claim 1.

14. The supported catalyst of claim 13, wherein the support is alumina.

15. The supported catalyst of claim 13, wherein the alumina is yalumina.

16. The supported catalyst of claim 11, which is about 1.0 wt. % Pt loading.

17. A proton exchange membrane fuel cell, comprising an anode, cathode and electrolyte, wherein said anode comprises the PtRu nanoparticles of claim 1.

18. A method of conducting oxidation of hydrogen, which comprises electrolytically oxidizing hydrogen in the proton exchange membrane fuel cell of claim 17.

19. The method of claim 18, wherein said hydrogen comprises a CO content up to about 10,000 ppm by volume.

20. A method of preparing the PtRu nanoparticles of claim 1, which comprises the steps of:
a) preparing ruthenium-based core nanoparticles, and
b) coating the ruthenium-based core nanoparticles with platinum, thereby producing the PtRu nanoparticles.

21. The method of claim 20, wherein steps a) and b) are conducted in high-boiling solvent.

22. The method of claim 21, wherein the solvent is a glycol.
